(19) United States
(12) Patent Application Publication
(10) Pub. No.: US 2024/0292097 A1
(43) Pub. Date: Aug. 29, 2024

(54) SYSTEMS AND METHODS FOR CAMERA MODE SWITCHING

(71) Applicant: Comcast Cable Communications, LLC, Philadelphia, PA (US)

(72) Inventors: Hongcheng Wang, Arlington, VA (US); Zhe Wu, Philadelphia, PA (US); Abhilash Sivan, Philadelphia, PA (US); Vijayanand Dubey, Philadephia, PA (US)

(21) Appl. No.: 18/175,899

(22) Filed: Feb. 28, 2023

(51) Int. Cl. H04N 23/667; G06T 7/50; H04N 23/71; H04N 23/73

(52) U.S. Cl. CPC H04N 23/667; G06T 7/50; H04N 23/71; H04N 23/73

(57) ABSTRACT

Methods, apparatuses, and systems are described for capturing images of a scene or environment. Parameters may be determined for a first area and a second area of a captured image. Based on the parameters, an image capture mode may be enabled. Images may be captured based on the image capture mode.

### BACKGROUND

Conventional cameras with high dynamic range (HDR) capabilities and day/night modes require users to manually switch between HDR and non-HDR modes. In addition, switching between day and night modes is based on the overall lighting of the scene. However, enabling HDR for capturing images does not always produce the best results. For example, enabling HDR for a well-lit scene may create wash-out effects in the captured images. Furthermore, enabling HDR when the lighting in the background is bright may cause the foreground to appear dark. Thus, objects in the foreground may be unrecognizable due to the dark foreground.

### SUMMARY

It is to be understood that both the following general description and the following detailed description are exemplary and explanatory only and are not restrictive. Methods, systems, and apparatuses systems for improved image capturing are described.

A capture device (e.g., a camera) connected to a network may generate and/or maintain images of a scene/environment. A depth estimation, or distribution, of the scene may be determined. The scene may be divided into a near-field scene (e.g., foreground) and a far-field scene (e.g., background) based on the depth estimation, or distribution. An average intensity associated with the near-field scene and an average intensity associated with the far-field may be determined. The average far-field intensity and the average near-field intensity may be used to determine a HDR index. The HDR index may be used to determine whether to enable or disable an HDR image capture mode of the capture device.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system environment;

FIGS. 2A-2D show example images captured by a capture device;

FIGS. 3A-3B show example images captured by a capture device;

FIG. 4 shows example images captured by a capture device;

FIG. 5A shows a flowchart of an example method;

FIG. 5B shows a flowchart of an example method;

FIG. 6A shows a flowchart of an example method;

FIG. 6B shows a flowchart of an example method;

FIG. 7 shows a flowchart of an example method;

FIG. 8 shows a flowchart of an example method;

FIG. 9 shows a flowchart of an example method; and

FIG. 10 shows a block diagram of an example system and computing device.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

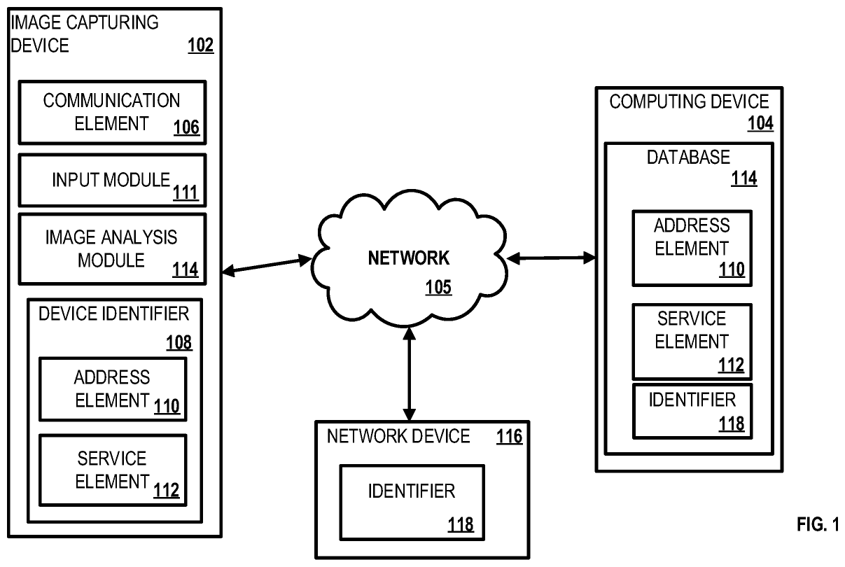

FIG. 1 shows an example system 100 for processing images of a scene captured by a device (e.g., an image capturing device 102). For example, the system 100 may be configured to determine a parameter ratio (e.g., HDR contrast ratio or HDR index) associated with a captured image, wherein the parameter ratio may be used to determine whether to enable/disable a high dynamic range (HDR) image capture mode. The system 100 may be configured to provide services, such as network-related services, to the device. The network and system may comprise an image capturing device 102 and/or a network device 116 in communication with a computing device 104, such as a server, via a network 105. The computing device 104 may be disposed locally or remotely relative to the image capturing device 102. As an example, the image capturing device 102 and/or the network device 116 and the computing device 104 can be in communication via a private and/or public network 105 such as the Internet or a local area network (LAN). Other forms of communications can be used such as wired and wireless telecommunication channels, for example.

The image capturing device 102 may comprise a user device configured to capture images of a scene. For example, the user device may comprise an electronic device such as a camera device, a smart camera, a video doorbell, a smart television, a computer, a smartphone, a laptop, a tablet, a display device, or other device capable of capturing images, video, and/or audio and communicating with the computing device 104.

The image capturing device 102 may comprise a communication element 106 for providing an interface to a user to interact with the image capturing device 102 and/or the computing device 104. The communication element 106 may be any interface for presenting and/or receiving information to/from the user, such as user input and/or a notification, confirmation, or the like associated with a region of interest (ROI), an object, or an action/motion within a field of view of the image capturing device 102. An example interface may be a communication interface such as a web browser (e.g., Internet Explorer®, Mozilla Firefox®, Google Chrome®, Safari®, or the like). Other software, hardware, and/or interfaces may be used to provide communication between the user and one or more of the image capturing device 102 and the computing device 104. As an example, the communication element 106 can request or query various files from a local source and/or a remote source. As an example, the communication element 106 can transmit data to a local or remote device such as the computing device 104.

The image capturing device 102 may be associated with a user identifier or a device identifier 108. As an example, the device identifier 108 may be any identifier, token, character, string, or the like, for differentiating one image capturing device (e.g., image capturing device 102) from another image capturing device. In an example, the device identifier 108 may identify a user or user device as belonging to a particular class of users or user devices. As an example, the device identifier 108 may comprise information relating to the image capturing device 102 such as a manufacturer, a model or type of device, a service provider associated with the image capturing device 102, a state of the image capturing device 102, a locator, and/or a label or classifier. Other information can be represented by the device identifier 108.

The device identifier 108 may comprise an address element 110 and a service element 112. In an example, the address element 110 can comprise or provide an internet protocol address, a network address, a media access control (MAC) address, international mobile equipment identity (IMEI) number, international portable equipment identity (IPEI) number, an Internet address, or the like. As an example, the address element 110 can be relied upon to establish a communication session between the image capturing device 102 and the computing device 104 or other devices and/or networks. As an example, the address element 110 can be used as an identifier or locator of the image capturing device 102. In an example, the address element 110 can be persistent for a particular network.

The service element 112 may comprise an identification of a service provider associated with the image capturing device 102, with the class of image capturing device 102, and/or with a particular network 105 with which the image capturing device 102 is currently accessing services associated with the service provider. The class of the device 102 may be related to a type of device, capability of device, type of service being provided, and/or a level of service (e.g., business class, service tier, service package, etc.). As an example, the service element 112 may comprise information relating to or provided by a communication service provider (e.g., Internet service provider) that is providing or enabling data flow such as communication services to the image capturing device 102. As an example, the service element 112 may comprise information relating to a preferred service provider for one or more particular services relating to the image capturing device 102. In an example, the address element 110 can be used to identify or retrieve data from the service element 112, or vice versa. As an example, one or more of the address element 110 and the service element 112 may be stored remotely from the image capturing device 102 and retrieved by one or more devices such as the image capturing device 102 and the computing device 104. Other information may be represented by the service element 112.

The image capturing device 102 may comprise an input module 111. The input module 111 may comprise one or more cameras (e.g., video cameras) and/or microphones that may be used to capture one or more images (e.g., video, etc.) and/or audio of a scene/environment within its field of view.

The image capturing device 102 may comprise an image analysis module 120. The image analysis module 120 may be configured to analyze one or more images (e.g., video, frames of video, etc.) determined/captured by the image capturing device 102 and enable/disable an image capture mode based on analyzing the one or more images. For example, the image analysis module 120 may be configured to perform one or more image analysis processes of a captured image to determine information associated with the captured image. The information associated with the captured image may comprise data indicative of a depth estimation/distribution of one or more pixels associated with the captured image. For example, the depth distribution may comprise one or more Gaussian distributions of the one or more pixels associated with the captured image. In an example, the image analysis module 120 may be configured to use a deep learning-based model to estimate a scene depth of the captured image. The scene/image may be divided into a first area and a second area based on the estimated scene depth. For example, the first area may comprise a near-field region (e.g., foreground) and the second area may comprise a far-field region (e.g., background). The image analysis module 120 may be configured to use the information associated with the captured image to determine a first parameter associated with the first area of the image and a second parameter associated with the second area of the image. The first parameter may be comprise an average intensity associated with the first area of the image and the second parameter may comprise an average intensity associated with the second area of the image. For example, the average intensity may be associated with a level of brightness associated with the pixels in the first area or the second area of the image. The image analysis module 120 may be configured to determine a parameter ratio based on the first parameter and the second parameter. For example, the parameter ratio may comprise a HDR contrast ratio (e.g., HDR index) associated with an average intensity associated with far-field region and an average intensity associated with the near-field region. For example, the parameter ratio may comprise the average intensity associated with far-field region divided by the average intensity associated with the near-field region. The image analysis module 120 may be configured to enable/disable an image capture mode based on the parameter ratio. For example, the image capture mode may comprise one or more of a HDR image capture mode or a night-time image capture mode. As an example, the image analysis module 120 may be configured to enable/disable an image capture mode based the parameter ratio satisfying a threshold. For example, based on a very high parameter ratio (e.g., an HDR index of 5.37), the image analysis module 120 may adjust an exposure time associated with capturing an image and enable the HDR image capture mode. For example, based on a high parameter ratio (e.g., an HDR index of 3.12), the image analysis module 120 may simply enable the HDR image capture mode without adjusting the exposure time. For example, based on a low parameter ratio (e.g., an HDR index of 2.3 or lower), the image analysis module 120 may disable the HDR image capture mode. In an example, the image analysis module 120 may be configured to provide the parameter ratio to a machine learning model, wherein the machine learning model may be configured to determine whether to enable/disable an image capture mode and/or adjust an exposure time based on the provided parameter ratio.

As an example, the image analysis module 120 may be configured to enable/disable a night-time/daytime image capture mode. For example, based on a high parameter ratio (e.g., a HDR index with a low average near-field intensity), the image analysis module 120 may enable the night-time and the HDR image capture modes. For example, based on a low parameter ratio (e.g. a low HDR index with low average near-field and far-field average intensities), the image analysis module 120 may simply enable the night-time image capture mode without enabling the HDR image capture mode. For example, based on a low parameter ratio (e.g. a low HDR index with high average near-field and far-field average intensities), the image analysis module 120 may disable both the night-time and HDR image capture mode and/or enable a daytime image capture mode. In an example, the image analysis module 120 may be configured to provide the parameter ratio to a machine learning model, wherein the machine learning model may be configured to determine whether to enable/disable the night-time/daytime image capture modes based on the provided parameter ratio.

The image capturing device 102 may use the communication element 106 to notify the user of image capture mode events such as the switching of the image capture mode from a first image capture mode to a second image capture mode. The notification may be sent to the user via a short range communication technique (e.g., BLUETOOTH®, near-field communication, infrared, etc.) or a long range communication technique (e.g., WIFI, cellular, satellite, Internet, etc.). The notification may comprise a text message, a notification/indication via an application, an email, a call, or any type of notification. For example, the user may receive a message, via the image capturing device 102, such as “are you interested in continuing to capture images using the current image capture mode?”, “do you want to be notified of image capture mode change events?”, or any other type of message. If the user does not desire continued notification of the image capture mode events, the image capturing device 102 may cease such notifications. By ceasing the image capture mode event notifications, the image capturing device 102 may avoid/reduce notifications of image capture mode events.

The computing device 104 may comprise a server for communicating with the image capturing device 102 and/or the network device 116. As an example, the computing device 104 may communicate with the image capturing device 102 for providing data and/or services. As an example, the computing device 104 may provide services, such as network (e.g., Internet) connectivity, network printing, media management (e.g., media server), content services, streaming services, broadband services, or other network-related services. As an example, the computing device 104 may allow the image capturing device 102 to interact with remote resources, such as data, devices, and files. As an example, the computing device 104 may be configured as (or disposed at) a central location (e.g., a headend, or processing facility), which may receive content (e.g., data, input programming) from multiple sources. The computing device 104 may combine the content from the multiple sources and may distribute the content to user (e.g., subscriber) locations via a distribution system.

The computing device 104 may be configured to manage the communication between the image capturing device 102 and a database 114 for sending and receiving data therebetween. As an example, the database 114 may store a plurality of files (e.g., web pages, images, etc.), user identifiers or records, or other information. As an example, the image capturing device 102 may request and/or retrieve a file from the database 114. In an example, the database 114 may store information relating to the image capturing device 102 such as the address element 110 and/or the service element 112. As an example, the computing device 104 may obtain the device identifier 108 from the image capturing device 102 and retrieve information from the database 114 such as the address element 110 and/or the service element 112. As an example, the computing device 104 may obtain the address element 110 from the image capturing device 102 and may retrieve the service element 112 from the database 114, or vice versa. Any information may be stored in and retrieved from the database 114. The database 114 may be disposed remotely from the computing device 104 and accessed via direct or indirect connection. The database 114 may be integrated with the computing device 104 or some other device or system.

The network device 116 may be in communication with a network, such as the network 105. For example, the network device 116 may facilitate the connection of a device (e.g., image capturing device 102) to the network 105. As an example, the network device 116 may be configured as a set-top box, a gateway device, or wireless access point (WAP). In an example, the network device 116 may be configured to allow one or more wireless devices to connect to a wired and/or wireless network using Wi-Fi, Bluetooth®, Zigbee®, or any desired method or standard. In an example, the network device 116 may be configured as a local area network (LAN). The network device 116 may be a dual band wireless access point. The network device 116 may be configured with a first service set identifier (SSID) (e.g., associated with a user network or private network) to function as a local network for a particular user or users. The network device 116 may be configured with a second service set identifier (SSID) (e.g., associated with a public/community network or a hidden network) to function as a secondary network or redundant network for connected communication devices.

The network device 116 may comprise an identifier 118. As an example, the identifier 118 may be or relate to an Internet Protocol (IP) Address (e.g., IPV4/IPV6) or a media access control address (MAC address) or the like. As an example, the identifier 118 may be a unique identifier for facilitating communications on the physical network segment. In an example, the network device 116 may comprise a distinct identifier 118. As an example, the identifier 118 may be associated with a physical location of the network device 116.

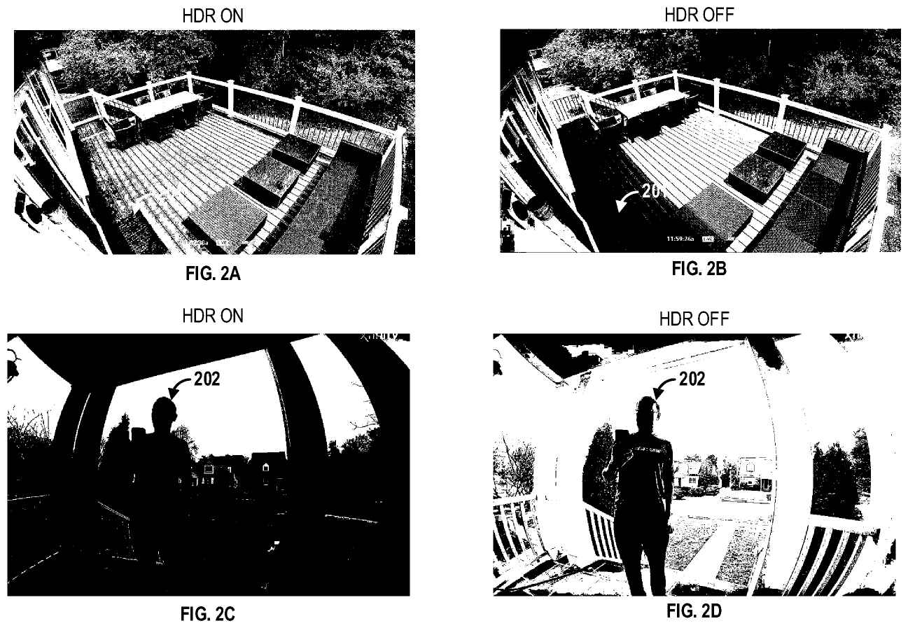

FIGS. 2A-2D show example images of a scene/environment captured by an image capturing device (e.g., image capturing device 102). FIG. 2A and FIG. 2C show examples of images captured using an HDR image capture mode and FIG. 2B and FIG. 2D show examples of images captured after disabling, or without, the HDR image capture mode. As an example, FIG. 2A and FIG. 2C show images where use of the HDR image capture mode may be unnecessary due to a well-lit scene. FIG. 2A shows an object within the image may be washed out when the HDR image capture mode is enabled while capturing images of a well-lit scene, and thus, and not easily identifiable, such as a doormat 201, in the bottom-left area of the image. For example, one or more image analysis processes may be performed on images being captured of the scene/environment. An average intensity level (e.g., average brightness level) of pixels in a foreground area of the image and an average intensity level (e.g., average brightness level) of pixels in a background area of the image may be determined based on the one or more image analysis processes of the images being captured. In an example, as shown in FIG. 2A, the doormat 201 may comprise a color similar to the color of the porch. Due to the enabled HDR image capture mode, the doormat 201 may become washed out, and thus, may blend in with the porch in the captured images. FIG. 2B, shows that by disabling the HDR image capture mode for a well-lit scene the doormat 201 may become more easily identifiable since it is no longer washed-out due to the HDR image capture mode. As an example, FIG. 2C and FIG. 2D show images where use of the HDR image capture causes the foreground to appear dark. As shown in FIG. 2C, a person 202 may be captured in the image. For example, a video doorbell device may be used at a front door to capture images of people that may approach the front door. Enabling the HDR may cause the person 202 in the foreground to appear dark, as shown in FIG. 2C, and thus, unrecognizable. FIG. 2D shows that by disabling the HDR image capture mode when the lighting in the background is bright, the person 202 is not caused to appear dark, and thus, becomes more recognizable.

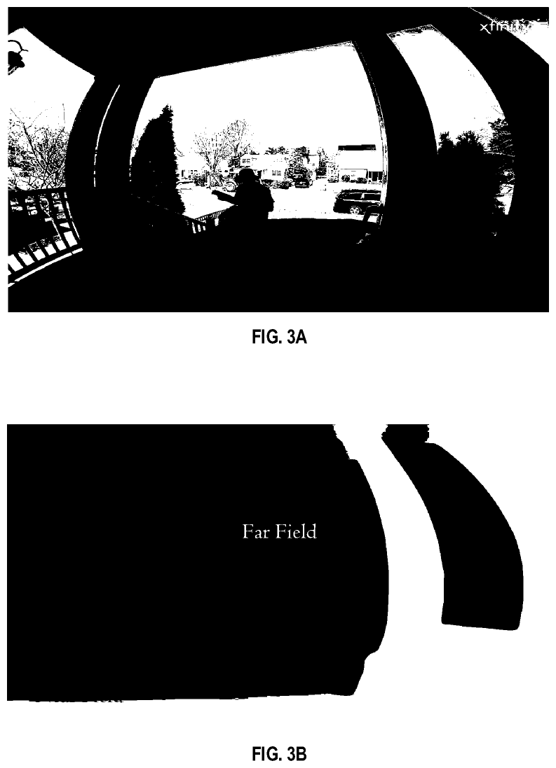

FIGS. 3A-3B show example images of a scene (e.g., environment) used to determine whether to enable/disable an HDR image capture mode. For example, FIG. 3A shows a capture image of a scene/environment in front an image capturing device. FIG. 3B shows a depth map of the captured image from FIG. 3A. For example, the image capturing device may perform one or more image analysis methods of a captured image to determine information associated with the captured image. In an example, the image capturing device may perform the one or more image analysis methods on a raw image of the captured image. The information associated with the captured image may comprise data indicative of a depth estimation/distribution of one or more pixels associated with the captured image. For example, the depth distribution may comprise one or more Gaussian distributions of the one or more pixels associated with the captured image. For example, the image capturing device may use a deep learning-based model (e.g., convolutional neural network, etc.) to estimate a scene depth of a captured image. For example, the deep learning-based model (e.g., convolutional neural network, etc.) may apply a weight-based filter across every element of a captured image to determine pixels associated with a near-field area (e.g., foreground) of the image and pixels associated with a far-field area (e.g., background) of the image. As shown in FIG. 3B, the pixels associated with the far-field (e.g., background) area may appear darker, or black, while the pixels associated with the near-field (e.g., foreground) area may appear lighter, or light gray.

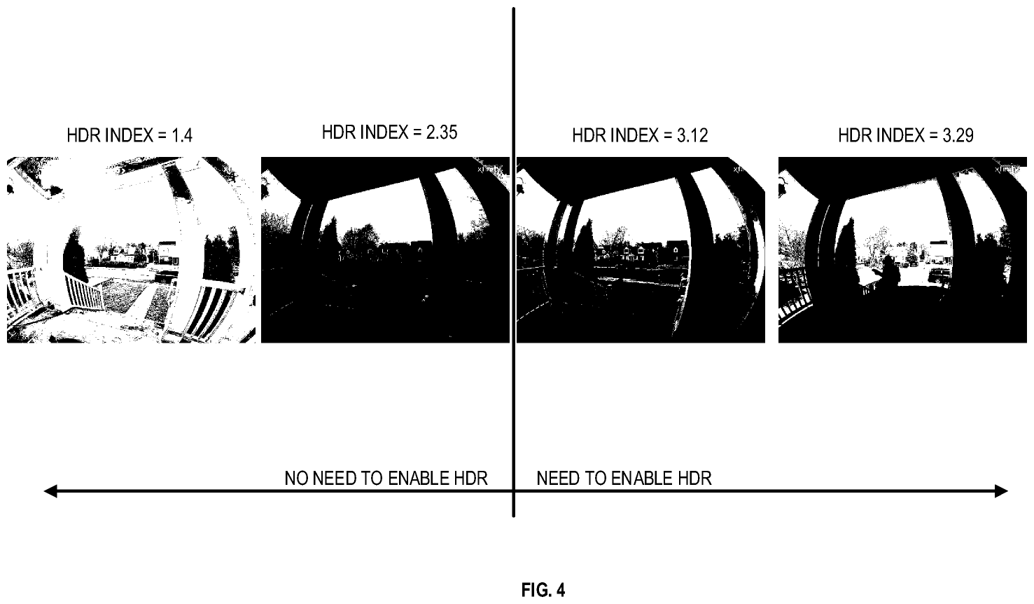

FIG. 4 shows example images captured by an image capturing device wherein an HDR image capture mode may be enabled/disabled based on a parameter ratio threshold. For example, enabling HDR for a well-lit scene may create wash-out effects in the captured images while enabling HDR when the lighting in the background is bright may cause the foreground to appear dark. As an example, an image capturing device may determine a depth distribution of one or more pixels of the captured image. Based on the depth distribution of the pixels, a near-field area (e.g., foreground) of the captured image and a far-field area (e.g., background) of the captured image may be determined. In an example, a raw image of the captured image may be used to determine the intensities for each pixel (e.g., brightness level for each pixel). Based on the determined depth distribution and the raw image data (e.g., pixel intensities), an average intensity may be determined for the near-field and the far-field areas of the image. For example, the average intensities may be associated with an average brightness level of the pixels in the far-field area of the image and the near-field area of the image. The parameter ratio may be determined based on the average intensities of the near-field and the far-field areas of the image. For example, the parameter ratio may comprise a value (e.g., HDR index) comprising the average far-field intensity divided by the average near-field intensity. The parameter ratio may be compared to a threshold to determine whether to enable/disable the HDR image capture mode. In an example, as shown in FIG. 4, based on a high parameter ratio (e.g., HDR Index of 3.12 or 3.29), the HDR image capture mode may be enabled. In an example, as shown in FIG. 4, based on a low parameter ratio (e.g., HDR Index of 1.4 or 2.35), the HDR image capture mode may be disabled. In an example, based on a very high parameter ratio (e.g., HDR Index greater than 4), an exposure time associated with capturing an image may be adjusted before enabling the HDR image capture mode.

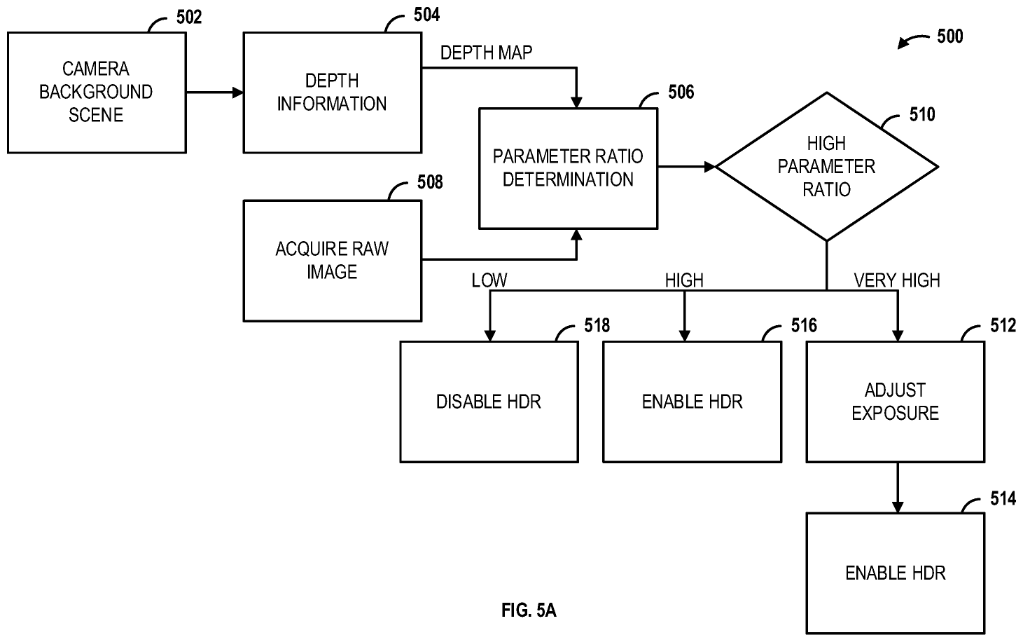

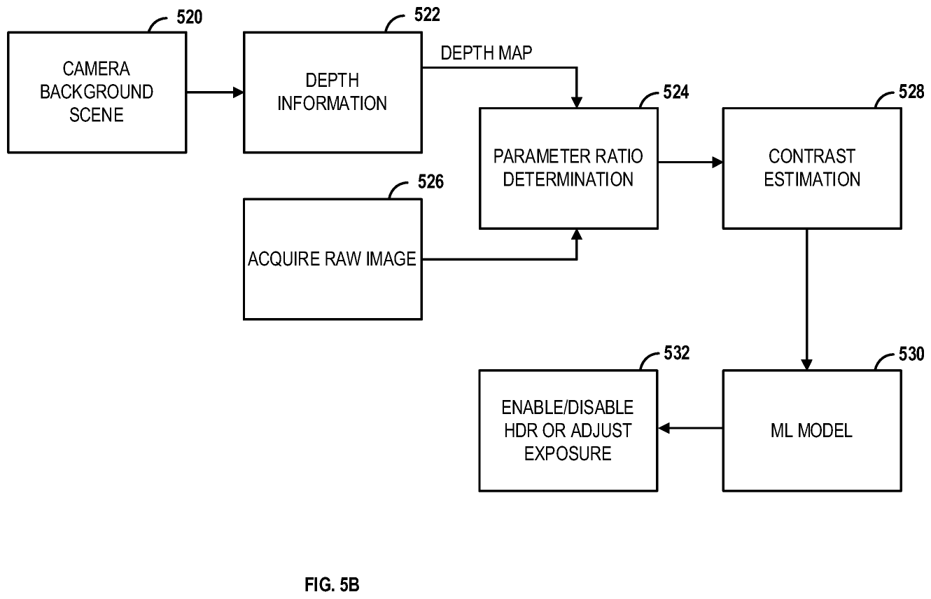

FIG. 5A shows a flowchart of an example method for determining whether to enable/disable an HDR image capture mode. At 502, an image of a scene/environment may be received. For example, an image capturing device (e.g., camera, video doorbell, smart camera, etc.) may capture images of a scene/environment in front of the camera. At 504, depth information associated with a captured image may be determined. In an example, an image capturing device may determine information associated with the captured image. For example, the image capturing device may be configured to perform one or more image analysis processes of the captured image to determine the information associated with the captured image. The information associated with the captured image may comprise data indicative of a depth estimation/distribution of one or more pixels associated with a captured image. For example, the depth distribution may comprise one or more Gaussian distributions of the one or more pixels associated with the captured image. In an example, a deep learning-based model may be used to estimate a scene depth of the captured image. The deep learning-based model (e.g., convolutional neural network, etc.) may apply a weight-based filter across every element of a captured image to determine pixels associated with a near-field area (e.g., foreground) of the image and pixels associated with a far-field area (e.g., background) of the image.

At 506, a parameter ratio (e.g., HDR index) may be determined. For example, an image capturing device may determine a parameter ratio associated with the captured image. An average intensity may be determined for pixels associated with the near-field area of the image while an average intensity may be determined for pixels associated with the far-field area of the image. The parameter ratio may be determined based on the average intensities of the near-field and the far-field areas of the image. For example, the parameter ratio may comprise a value (e.g., HDR index) comprising the average far-field intensity divided by the average near-field intensity. In an example, at 508, a raw image version of the captured image may be used to determine the parameter ratio. As an example, raw image data may be compared with the parameter ratio associated with the captured image to determine a final parameter ratio. As an example, the raw image data may be used with the intensity levels of the pixels associated with the near-field and far-field areas of the captured image. The raw image data may be used to further refine the average intensities associated with the near-field and far-field areas of the captured image and determine the parameter ratio.

At 510, the parameter ratio may be compared to one or more thresholds to determine whether to enable/disable the HDR image capture mode. If the parameter ratio is very high (e.g., HDR index greater than 4), the branch is followed to 512, wherein an exposure time associated with capturing an image may be adjusted and then, at 514, the HDR image capture mode may be enabled. If the parameter ratio is high (e.g., HDR index between 2.5 and 4), the branch is followed to 516, wherein the HDR image capture mode may simply be enabled without adjusting the exposure time. If the parameter ratio is low (e.g., HDR index below 2.5), the branch is followed to 518, wherein the HDR image capture mode may be disabled.

FIG. 5B shows a flowchart of an example method for determining whether to enable/disable an HDR image capture mode. Steps 520-526 are similar to steps 502-508 of FIG. 5A. At 528, a machine learning model may replace the decision branch at 510 of FIG. 5A. For example, a machine learning model may be trained using parameter ratio data associated with average intensities of near-field and far-field areas of a plurality of images. Based on the trained machine learning model, a parameter ratio associated with a captured image may be provided to the trained machine learning model at 528, wherein the trained machine learning model may determine whether to enable/disable the HDR image capture mode and/or adjust the exposure time, at 530, based on the received parameter ratio.

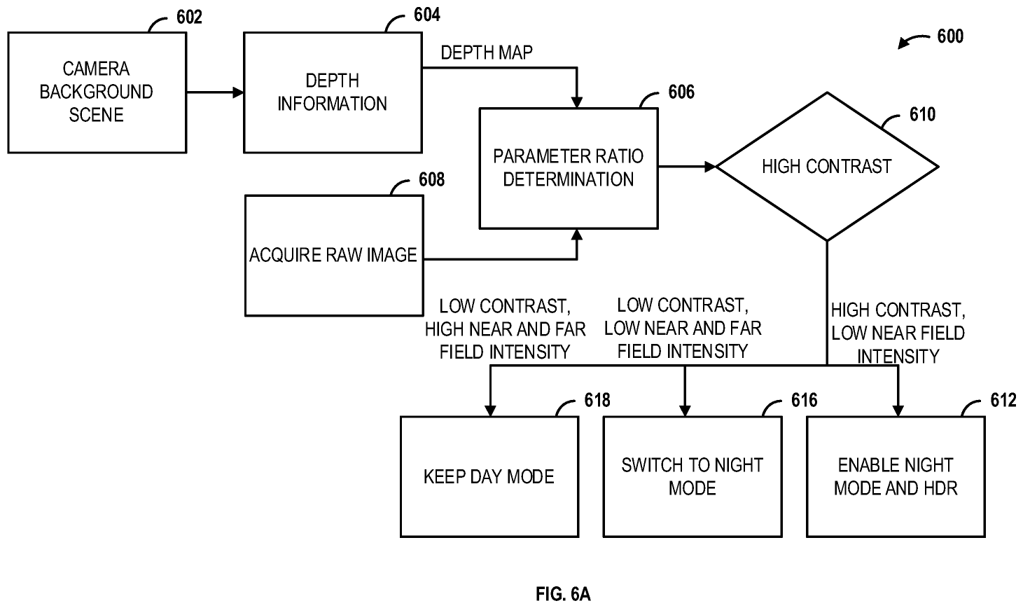

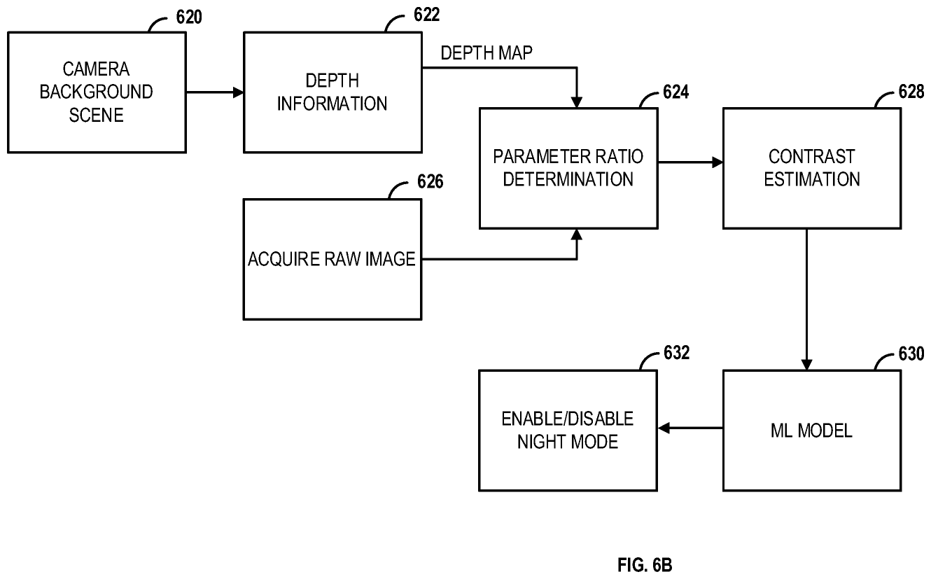

FIG. 6A shows a flowchart of an example method for determining whether to enable/disable a night-time image capture mode. Steps 602-608 are similar to steps 502-508 of FIG. 5A. At 610, the parameter ratio may be compared to one or more thresholds to determine whether to enable/disable a night-time image capture mode and/or a HDR image capture mode. If the parameter ratio is high (e.g., low near-field intensity), the branch is followed to 612, wherein the night-time image capture mode and the HDR image capture mode may be enabled. If the parameter ratio is low (e.g., low near-field intensity and low far-field intensity), the branch is followed to 616, wherein the night-time image capture mode may be enabled without enabling the HDR image capture mode. If the parameter ratio is low (e.g., high near-field intensity and high far-field intensity), the branch is followed to 618, wherein the night-time image capture mode may be disabled, or a daytime image capture mode may be enabled.

FIG. 6B shows a flowchart of an example method for determining whether to enable/disable a night-time image capture mode. Steps 620-626 are similar to steps 502-508 of FIG. 5A. At 628, a machine learning model may replace the decision branch at 610 of FIG. 6A. For example, a machine learning model may be trained using parameter ratio data associated with average intensities of near-field and far-field areas of a plurality of images. Based on the trained machine learning model, a parameter ratio associated with a captured image may be provided to the trained machine learning model at 628, wherein the trained machine learning model may determine whether to enable/disable the night-time image capture mode and/or enable/disable the HDR image capture mode, at 630, based on the received parameter ratio.

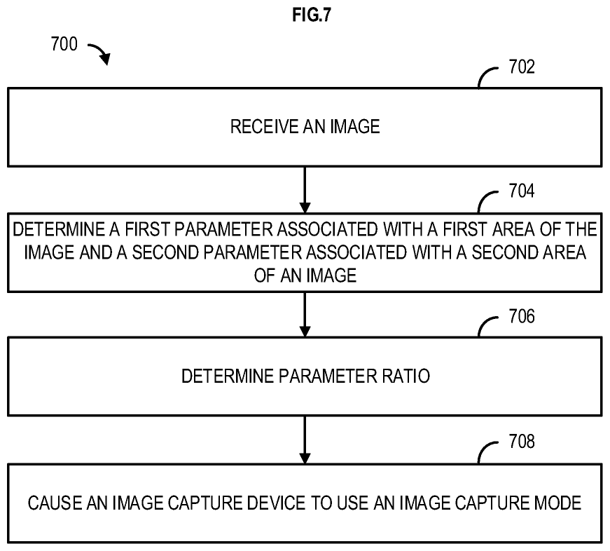

FIG. 7 shows a flowchart of an example method 700 for causing an image capture device to use an image capture mode. Method 700 may be implemented by an image capturing device (e.g., image capturing device 102), wherein the image capturing device may comprise a camera device, a smart camera, a video doorbell, a smart television, a computer, a smartphone, a laptop, a tablet, a display device, or other device capable of capturing images, video, and/or audio. At step 702, an image may be received. For example, the image may be received by the image capturing device. As an example, an image may be captured, by the image capturing device, of a scene/environment in front of the image capturing device.

At step 704, a first parameter associated with a first area of the image and a second parameter associated with a second area of the image may be determined based on an analysis of the image. For example, the first parameter and the second parameter may be determined by the image capturing device based on the analysis of the image. For example, one or more image analysis processes may be performed on the image to determine information associated with the image. The information associated with the image may comprise a depth distribution of one or more pixels associated with the image. The depth distribution may comprise one or more Gaussian distributions of the one or more pixels associated with the image. For example, a deep learning-based model may be used to estimate a scene depth of the image. The deep learning-based model (e.g., convolutional neural network, etc.) may apply a weight-based filter across every element of a captured image to determine pixels associated with a near-field area (e.g., foreground) of the image and pixels associated with a far-field area (e.g., background) of the image. The first parameter may comprise an average intensity associated with the first area of the image. For example, the first area of the image may comprise a near-field scene/area (e.g., foreground) of an environment captured by the image capture device. The average intensity of the first parameter may be associated a brightness level associated with the pixels associated with the near-field scene/area. The second parameter may comprise an average intensity associated with the second area of the image. For example, the second area of the image may comprise a far-field scene/area (e.g., background) of an environment captured by the image capture device. The average intensity of the second parameter may be associated a brightness level associated with the pixels associated with the far-field scene/area.

At step 706, a parameter ratio (e.g., HDR index) may be determined based on the first parameter and the second parameter. For example, the parameter ratio may be determined by the image capturing device based on the first parameter and the second parameter. For example, the parameter ratio may be determined based on the average intensities of the near-field and the far-field scenes/areas of the image. For example, the parameter ratio may comprise a value (e.g., HDR index) comprising the average far-field intensity divided by the average near-field intensity.

At step 708, an image capture mode may be used based on the parameter ratio satisfying a threshold. For example, the image capturing device may be caused to use the image capture mode based on the parameter ratio satisfying the threshold. The image capture mode may comprise one or more of a high dynamic range (HDR) image capture mode or a night-time image capture mode. As an example, an exposure time associated with capturing the image may be adjusted based on the parameter ratio satisfying the threshold. The image capture mode may be used based on the adjusted exposure time. For example, if the parameter ratio is very high (e.g., HDR index greater than 4), the exposure time may be adjusted and then the HDR image capture mode may be enabled. As an example, the parameter ratio may be determined to not satisfy a first threshold. The parameter ratio may be determined to satisfy a second threshold based on not satisfying a first threshold. The image capture mode may be enabled based on the parameter ratio satisfying the second threshold. For example, if the parameter ratio is high (e.g., HDR index between 2.5 and 4), the HDR image capture mode may be enabled without adjusting the exposure time. As an example, a night-time image capture mode and the HDR image capture mode may be used based on the parameter ratio satisfying the threshold. For example, if the parameter ratio is high (e.g., low near-field intensity), the night-time image capture mode and the HDR image capture mode may be enabled. As an example, the first parameter may be determined to comprise a low average intensity and the second parameter may be determined to comprise a low average intensity based on the parameter ratio satisfying the threshold. The image capture mode may be used based on the first parameter comprising the low average intensity and the second parameter comprising the low average intensity. For example, if the parameter ratio is low (e.g., low near-field intensity and low far-field intensity), the night-time image capture mode may be enabled without enabling the HDR image capture mode. In example, the image capture device may capture one or more images based on the image capture mode. In an example, causing the image capturing device to use the image capture mode may comprise causing the image capturing device to switch from a first image capture mode to a second image capture mode.

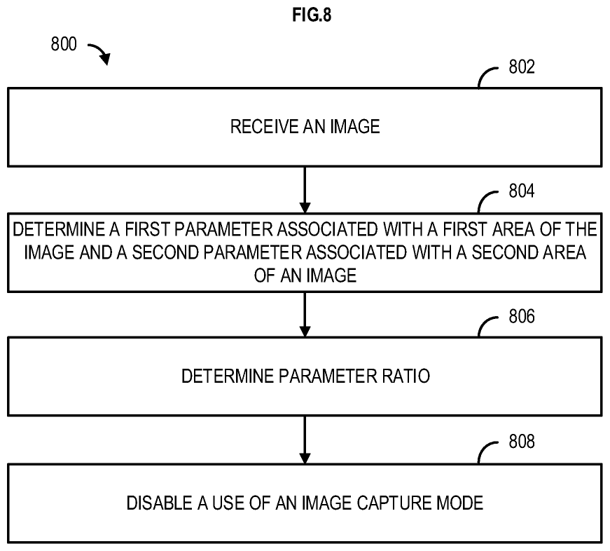

FIG. 8 shows a flowchart of an example method 800 for causing an image capture device to use an image capture mode. Method 800 may be implemented by an image capturing device (e.g., image capturing device 102), wherein the image capturing device may comprise a camera device, a smart camera, a video doorbell, a smart television, a computer, a smartphone, a laptop, a tablet, a display device, or other device capable of capturing images, video, and/or audio. At step 802, an image may be received. For example, the image may be received by the image capturing device. As an example, an image may be captured, by the image capturing device, of a scene/environment in front of the image capturing device.

At step 804, a first parameter associated with a first area of the image and a second parameter associated with a second area of the image may be determined based on an analysis of the image. For example, the first parameter and the second parameter may be determined by the image capturing device based on the analysis of the image. For example, one or more image analysis processes may be performed on the image to determine information associated with the image. The information associated with the image may comprise a depth distribution of one or more pixels associated with the image. The depth distribution may comprise one or more Gaussian distributions of the one or more pixels associated with the image. For example, a deep learning-based model may be used to estimate a scene depth of the image. The deep learning-based model (e.g., convolutional neural network, etc.) may apply a weight-based filter across every element of a captured image to determine pixels associated with a near-field area (e.g., foreground) of the image and pixels associated with a far-field area (e.g., background) of the image. The first parameter may comprise an average intensity associated with the first area of the image. For example, the first area of the image may comprise a near-field scene/area (e.g., foreground) of an environment captured by the image capture device. The average intensity of the first parameter may be associated a brightness level associated with the pixels associated with the near-field scene/area. The second parameter may comprise an average intensity associated with the second area of the image. For example, the second area of the image may comprise a far-field scene/area (e.g., background) of an environment captured by the image capture device. The average intensity of the second parameter may be associated a brightness level associated with the pixels associated with the far-field scene/area.

At step 806, a parameter ratio (e.g., HDR index) may be determined based on the first parameter and the second parameter. For example, the parameter ratio may be determined by the image capturing device based on the first parameter and the second parameter. For example, the parameter ratio may be determined based on the average intensities of the near-field and the far-field scenes/areas of the image. For example, the parameter ratio may comprise a value (e.g., HDR index) comprising the average far-field intensity divided by the average near-field intensity.

At step 808, the use of an image capture mode may be disabled based on the parameter ratio not satisfying the threshold. For example, the image capturing device may be caused to disable the use of an image capture mode based on the parameter ratio not satisfying the threshold. The image capture mode may comprise one or more of a high dynamic range (HDR) image capture mode or a night-time image capture mode. As an example, the HDR image capture mode or the night-time image capture mode may be disabled based on the parameter not satisfying the threshold. As an example, the first parameter may be determined to comprise a high average intensity and the second parameter may be determined to comprise a high average intensity based on the parameter ratio not satisfying the threshold. The use of the image capture mode may be disabled based on the first parameter comprising the high average intensity and the second parameter comprising the high average intensity. For example, if the parameter ratio is low (e.g., HDR index below 2.5), the HDR image capture mode may be disabled. For example, if the parameter ratio is low (e.g., high near-field intensity and high far-field intensity), the night-time image capture mode may be disabled. In an example, instead of the HDR image capture and the night-time image capture mode, the image capturing device may be caused to capture one or more images based on a normal image capture mode. In an example, the normal image capture mode may comprise a day-time image capture mode. In an example, causing the image capturing device to use the image capture mode may comprise causing the image capturing device to switch from a first image capture mode to a second image capture mode.

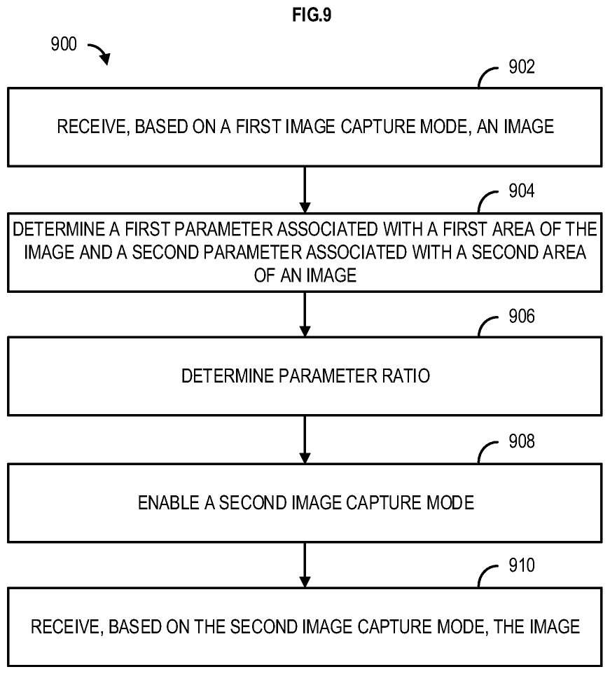

FIG. 9 shows a flowchart of an example method 900 for causing an image capture device to use an image capture mode. Method 900 may be implemented by an image capturing device (e.g., image capturing device 102), wherein the image capturing device may comprise a camera device, a smart camera, a video doorbell, a smart television, a computer, a smartphone, a laptop, a tablet, a display device, or other device capable of capturing images, video, and/or audio. At step 902, an image may be received based on a first image capture mode. For example, the image may be received by the image capturing device based on a first image capture mode. As an example, an image may be captured, by the image capturing device using the first image capture mode, of a scene/environment in front of the image capturing device. The first image capture mode may comprise a normal image capture mode, wherein images may be captured without the use of a high dynamic range (HDR) image capture mode or a night-time image capture mode. In an example, the normal image capture mode may comprise a daytime image capture mode.

At step 904, a first parameter associated with a first area of the image and a second parameter associated with a second area of the image may be determined based on an analysis of the image. For example, the first parameter and the second parameter may be determined by the image capturing device based on the analysis of the image. For example, one or more image analysis processes may be performed on the image to determine information associated with the image. The information associated with the image may comprise a depth distribution of one or more pixels associated with the image. The depth distribution may comprise one or more Gaussian distributions of the one or more pixels associated with the image. For example, a deep learning-based model may be used to estimate a scene depth of the image. The deep learning-based model (e.g., convolutional neural network, etc.) may apply a weight-based filter across every element of a captured image to determine pixels associated with a near-field area (e.g., foreground) of the image and pixels associated with a far-field area (e.g., background) of the image. The first parameter may comprise an average intensity associated with the first area of the image. For example, the first area of the image may comprise a near-field scene/area (e.g., foreground) of an environment captured by the image capture device. The average intensity of the first parameter may be associated a brightness level associated with the pixels associated with the near-field scene/area. The second parameter may comprise an average intensity associated with the second area of the image. For example, the second area of the image may comprise a far-field scene/area (e.g., background) of an environment captured by the image capture device. The average intensity of the second parameter may be associated a brightness level associated with the pixels associated with the far-field scene/area.

At step 906, a parameter ratio (e.g., HDR index) may be determined based on the first parameter and the second parameter. For example, the parameter ratio may be determined by the image capturing device based on the first parameter and the second parameter. For example, the parameter ratio may be determined based on the average intensities of the near-field and the far-field scenes/areas of the image. For example, the parameter ratio may comprise a value (e.g., HDR index) comprising the average far-field intensity divided by the average near-field intensity.

At step 908, a second image capture mode may be enabled based on the parameter ratio not satisfying the threshold. For example, the image capturing device may enable the second image capture mode based on the parameter ratio not satisfying the threshold. The second image capture mode may comprise one or more of a HDR image capture mode or a night-time image capture mode. As an example, an exposure time associated with capturing the image may be adjusted based on the parameter ratio satisfying the threshold. The second image capture mode may be enabled based on the adjusted exposure time. For example, if the parameter ratio is very high (e.g., HDR index greater than 4), the exposure time may be adjusted and then the HDR image capture mode may be enabled. As an example, the parameter ratio may be determined to not satisfy a first threshold. The parameter ratio may be determined to satisfy a second threshold based on the parameter ratio not satisfying the first threshold. The second image capture mode may be enabled based on the parameter ratio satisfying the second threshold. For example, if the parameter ratio is high (e.g., HDR index between 2.5 and 4), the HDR image capture mode may be enabled without adjusting the exposure time. As an example, a night-time image capture mode and the HDR image capture mode may be used based on the parameter ratio satisfying the threshold. For example, if the parameter ratio is high (e.g., low near-field intensity), the night-time image capture mode and the HDR image capture mode may be enabled. As an example, the first parameter may be determined to comprise a low average intensity and the second parameter may be determined to comprise a low average intensity based on the parameter ratio satisfying the threshold. The second image capture mode may be enabled based on the first parameter comprising a low average intensity and the second parameter comprising a low average intensity. For example, if the parameter ratio is low (e.g., low near-field intensity and low far-field intensity), the night-time image capture mode may be enabled without enabling the HDR image capture mode. In example, the image capture device may capture the image using on the second image capture mode.

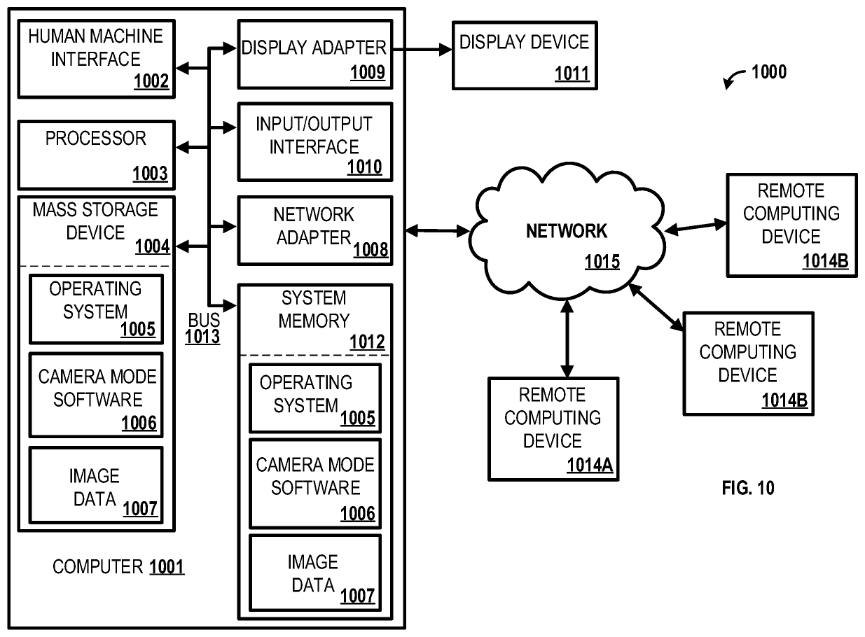

The methods and systems can be implemented on a computer 1001 as illustrated in FIG. 10 and described below. By way of example, computing device 104, image capturing device 102, and/or the network device 116 of FIG. 1 can be a computer 1001 as illustrated in FIG. 10. Similarly, the methods and systems disclosed can utilize one or more computers to perform one or more functions in one or more locations. FIG. 10 is a block diagram illustrating an example operating environment 1000 for performing the disclosed methods. This example operating environment 1000 is only an example of an operating environment and is not intended to suggest any limitation as to the scope of use or functionality of operating environment architecture. Neither should the operating environment 1000 be interpreted as having any dependency or requirement relating to any one or combination of components illustrated in the example operating environment 1000.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 1001. The computer 1001 can comprise one or more components, such as one or more processors 1003, a system memory 1012, and a bus 1013 that couples various components of the computer 1001 comprising the one or more processors 1003 to the system memory 1012. The system can utilize parallel computing.

The bus 1013 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and one or more of the components of the computer 1001, such as the one or more processors 1003, a mass storage device 1004, an operating system 1005, camera mode software 1006, image data 1007, a network adapter 1008, the system memory 1012, an Input/Output Interface 1010, a display adapter 1009, a display device 1011, and a human machine interface 1002, can be contained within one or more remote computing devices 1014A-1014C at physically separate locations, connected through buses of this form, in effect implementing a fully distributed system.

The computer 1001 typically comprises a variety of computer readable media. Examples of readable media can be any available media that is accessible by the computer 1001 and comprises, for example and not meant to be limiting, both volatile and non-volatile media, removable and non-removable media. The system memory 1012 can comprise computer readable media in the form of volatile memory, such as random access memory (RAM), and/or non-volatile memory, such as read only memory (ROM). The system memory 1012 typically can comprise data such as the image data 1007 and/or program modules such as the operating system 1005 and the camera mode software 1006 that are accessible to and/or are operated on by the one or more processors 1003.

In another aspect, the computer 1001 can also comprise other removable/non-removable, volatile/non-volatile computer storage media. The mass storage device 1004 can provide non-volatile storage of computer code, computer readable instructions, data structures, program modules, and other data for the computer 1001. For example, the mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1004, such as, by way of example, the operating system 1005 and the camera mode software 1006. One or more of the operating system 1005 and the camera mode software 1006 (or some combination thereof) can comprise elements of the programming and the camera mode software 1006. The image data 1007 can also be stored on the mass storage device 1004. The image data 1007 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1015.

In another aspect, the user can enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1003 via the human machine interface 1002 that is coupled to the bus 1013, but can be connected by other interface and bus structures, such as a parallel port, game port, an IEEE 1394 Port (also known as a Firewire port), a serial port, a network adapter 1008, and/or a universal serial bus (USB).

In yet another aspect, the display device 1011 can also be connected to the bus 103 via an interface, such as the display adapter 1009. It is contemplated that the computer 1001 can have more than one display adapter 1009 and the computer 1001 can have more than one display device 1011. For example, the display device 1011 can be a monitor, an LCD (Liquid Crystal Display), light emitting diode (LED) display, television, smart lens, smart glass, and/or a projector. In addition to the display device 1011, other output peripheral devices can comprise components such as speakers (not shown) and a printer (not shown) which can be connected to the computer 1001 via an Input/Output Interface 1010. Any step and/or result of the methods can be output in any form to an output device. Such output can be any form of visual representation, comprising, but not limited to, textual, graphical, animation, audio, tactile, and the like. The display device 1011 and the computer 1001 can be part of one device, or separate devices.

The computer 1001 can operate in a networked environment using logical connections to one or more remote computing devices 1014A-1014C. By way of example, a remote computing device 1014A-1014C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1001 and a remote computing device 1014A-1014C can be made via a network 1015, such as a local area network (LAN) and/or a general wide area network (WAN). Such network connections can be through the network adapter 1008. The network adapter 1008 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components can reside at various times in different storage components of the computing device 1001, and are executed by the one or more processors 1003 of the computer 1001. An implementation of the camera mode software 1006 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Example computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
receiving, from an image capture device, an image;
determining, based on an analysis of the image, a first parameter associated with a first area of the image and a second parameter associated with a second area of the image;
determining, based on the first parameter and the second parameter, a parameter ratio; and
based on the parameter ratio satisfying a threshold, causing the image capture device to use an image capture mode.

2. The method of claim 1, wherein determining, based on the analysis of the image, the first parameter associated with the first area of the image and the second parameter associated with the second area of the image comprises:
determining, based on the analysis of the image, a depth distribution of one or more pixels of the image; and
determining, based on the depth distribution of the one or more pixels, the first parameter associated with the first area of the image and the second parameter associated with the second area of the image.

3. The method of claim 1, wherein the first parameter comprises an average intensity associated with the first area of the image, and wherein the second parameter comprises an average intensity associated with the second area of the image.

4. The method of claim 1, wherein the first area of the image comprises a near-field scene of an environment captured by the image capture device, and wherein the second area of the image comprises a far-field scene of the environment captured by the image capture device.

5. The method of claim 1, wherein the image capture mode comprises one or more of a high dynamic range (HDR) image capture mode or a night-time image capture mode.

6. The method of claim 1, wherein based on the parameter ratio satisfying the threshold, causing the use of the image capture mode comprises:
based on the parameter ratio satisfying the threshold, adjusting an exposure time associated with capturing the image; and
causing, based on the adjusted exposure time, the use of the image capture mode.

7. The method of claim 1, wherein based on the parameter ratio satisfying the threshold, causing the use of the image capture mode comprises:
based on the parameter ratio not satisfying a first threshold, determining the parameter ratio satisfies a second threshold; and
based on the parameter ratio satisfying the second threshold, causing the use of the image capture mode.

8. The method of claim 1, wherein based on the parameter ratio satisfying the threshold, causing the use of the image capture mode comprises: based on the parameter ratio satisfying the threshold, causing the use of a night-time image capture mode and a high dynamic range (HDR) image capture mode.

9. The method of claim 1, wherein based on the parameter ratio satisfying the threshold, causing the use of the image capture mode comprises:
based on the parameter ratio satisfying the threshold, determining the first parameter comprises a low average intensity and the second parameter comprises a low average intensity; and
causing, based on the first parameter comprising a low average intensity and the second parameter comprising a low average intensity, the use of a night-time image capture mode.

10. A method comprising:
receiving, from an image capture device, an image;
determining, based on an analysis of the image, a first parameter associated with a first area of the image and a second parameter associated with a second area of the image;
determining, based on the first parameter and the second parameter, a parameter ratio; and
based on the parameter ratio not satisfying a threshold, disabling a use of an image capture mode.

11. The method of claim 10, wherein the first parameter comprises an average intensity associated with the first area of the image, and wherein the second parameter comprises an average intensity associated with the second area of the image.

12. The method of claim 10, wherein the image capture mode comprises one or more of a high dynamic range (HDR) image capture mode or a night-time image capture mode.

13. The method of claim 10, wherein based on the parameter ratio not satisfying the threshold, disabling the use of the image capture mode comprises: based on the parameter ratio not satisfying the threshold disabling the use of a high dynamic range (HDR) image capture mode or a night-time image capture mode.

14. The method of claim 10, wherein based on the parameter ratio not satisfying the threshold, disabling the use of the image capture mode comprises:
based on the parameter ratio not satisfying the threshold, determining the first parameter comprises a high average intensity and the second parameter comprises a high average intensity; and
based on the first parameter comprising a high average intensity and the second parameter comprising a high average intensity, disabling the use of the image capture mode.

15. A method comprising:
receiving, at a device, based on a first image capture mode, an image;
determining, based on an analysis of the image, a first parameter associated with a first area of the image and a second parameter associated with a second area of the image;
determining, based on the first parameter and the second parameter, a parameter ratio;
based on the parameter ratio satisfying a threshold, enabling a second image capture mode; and
receiving, based on the second image capture mode, the image.

16. The method of claim 15, wherein the first image capture mode comprises a day-time image capture mode, and wherein the second image capture mode comprise one or more of a high dynamic range (HDR) image capture mode or a night-time image capture mode.

17. The method of claim 15, wherein based on the parameter ratio satisfying the threshold, enabling the second image capture mode comprises:
based on the parameter ratio satisfying the threshold, determining an exposure time associated with capturing the image; and
enabling, based on the exposure time, the second image capture mode.

18. The method of claim 15, wherein based on the parameter ratio satisfying the threshold, enabling the second image capture mode comprises:
based on the parameter ratio not satisfying a first threshold, determining the parameter ratio satisfies a second threshold; and
based on the parameter ratio satisfying the second threshold, enabling the second image capture mode.

19. The method of claim 15, wherein based on the parameter ratio satisfying the threshold, enabling the second image capture mode comprises: based on the parameter ratio satisfying the threshold, enabling a night-time image capture mode and a high dynamic range (HDR) image capture mode.

20. The method of claim 15, wherein based on the parameter ratio satisfying the threshold, enabling the second image capture mode comprises:
based on the parameter ratio satisfying the threshold, determining the first parameter comprises a low average intensity and the second parameter comprises a low average intensity; and
enabling, based on the first parameter comprising a low average intensity and the second parameter comprising a low average intensity, a night-time image capture mode.
